(19) United States
(12) Patent Application Publication
(10) Pub. No.: US 2026/0035763 A1
(43) Pub. Date: Feb. 5, 2026

(54) METHOD FOR RECYCLING THE CRITICAL METALS FROM SPENT LITHIUM-ION BATTERIES

(71) Applicant: University of Kentucky Research Foundation, Lexington, KY (US)

(72) Inventors: Jian Shi, Lexington, KY (US); Yuxuan Zhang, Lexington, KY (US); Ahamed Ullah, Lexington, KY (US); Qing Shao, Lexington, KY (US); Xin Gao, Lexington, KY (US)

(21) Appl. No.: 19/109,757

(22) PCT Filed: Sep. 12, 2023
(86) PCT No.: PCT/US2023/032508

§ 371 Date: Mar. 7, 2025

Related U.S. Application Data
(60) Provisional application No. 63/405,803, filed on Sep. 12, 2022.

(51) Int. Cl. C22B 3/16; C22B 26/12; H01M 10/54

(52) U.S. Cl. CPC C22B 3/165; C22B 26/12; H01M 10/54

(57) ABSTRACT

A hydrophobic deep eutectic solvent includes a combination of at least two of (a) a hydrophobic component. (b) an acidic component, and (c) a reducing agent. The solvent is useful in a method of recovering critical metals from lithium-ion batteries. That method includes steps of: shredding the lithium-ion batteries to separate metal container and shell components from a black mass including graphite, copper, cathode, anode and electrolyte battery materials, leaching the black mass with a hydrophobic deep eutectic solvent to extract critical metals, including lithium, cobalt, nickel and manganese, and generate a pregnant hydrophobic deep eutectic solvent, and recovering the critical metals from the pregnant hydrophobic deep eutectic solvent.

### RELATED APPLICATION

This application claims priority to U.S. Provisional Patent Application Ser. No. 63/405,803 filed on Sep. 12, 2022, which is hereby incorporated by reference in its entirety.

### TECHNICAL FIELD

This document relates generally to hydrophobic deep eutectic solvents (hDESs) and use of those solvents in methods of recycling critical metals from spent lithium-ion batteries.

### BACKGROUND

The extensive usage of lithium-ion batteries (LIBs) in electronic devices and electric vehicles (EV) will produce an increasing amount of waste from dead batteries in the future. Among various parts, the cathode material is critical because it contains metals that are valuable and limited in quantity in nature. As a consequence, proper and efficient methods are needed to extract and recover these metal elements from the cathode materials of spent LIBs.

Toward this end, this document relates to novel hydrophobic binary/ternary/quaternary deep eutectic solvents (hDESs) for effective metal extraction. Those hDESs made of natural derived compounds such as menthol, thymol, and phenols have shown very high leaching efficiency and can mostly dissolve the lithium cobalt oxide, LiCoO₂ (LCO), lithium nickel manganese cobalt oxide (NMC), and similar types of battery active powder materials under mild leaching conditions. The selected hDESs have been tested using real black mass from spent batteries (mostly containing graphite, lithium, nickel, aluminum, cobalt, etc.) and the results support the use of these sustainable solvents for the recovery of critical metals from LIBs.

### SUMMARY

In accordance with the purposes and benefits set forth herein, new and improved deep eutectic solvents (hDESs) are provided. These hDESs comprise, consist of or consist essentially of (a) a combination of a hydrophobic component and an acidic component, (b) the hydrophobic component and a reducing agent, (c) the acidic component and the reducing agent or (d) the hydrophobic component, the acidic component and the reducing agent.

In at least some of the embodiments of the solvent, the hydrophobic component is selected from a group consisting of a derivative of lignin, menthol, thymol, 2,2-dimethoxypropane (DMP), napthol, lidocaine, vanillin, 4-hydroxybenzyl alcohol, phenol, a derivative of phenol, guaiacol, cresol, syringol, apocynin, syringaldehyde and mixtures thereof.

In at least some of the embodiments of the solvent, the acidic component is selected from a group consisting of an acid including one or more carboxylic functional groups, decanoic acid, formic acid, citric acid, lactic acid, dodecanoic acid, succinic acid, ascorbic acid, malic acid, oxalic acid, malonic acid, adipic acid, benzoic acid and mixtures thereof.

In at least some of the embodiments of the solvent, the reducing agent is selected from a group consisting of ethylene glycol, glycerol, diethylene glycol, ascorbic acid, malic acid, glucose, urea, thiourea, acetimide, benzamide, glycine, alanine, sorbitol and mixtures thereof.

In accordance with an additional aspect, a method of making a hydrophobic deep eutectic solvent, comprises, consists of or consists essentially of: (a) mixing at least two of a hydrophobic component, an acidic component and a reducing agent together in a vessel to create a mixture, (b) heating the mixture to a temperature of at least 80° C., and (c) stirring the mixture during heating.

In accordance with yet another aspect, a method of recovering critical metals from lithium-ion batteries, comprises, consists of or consists essentially of: (a) shredding the lithium-ion batteries to separate metal container and shell components from a black mass including graphite, copper, cathode, anode and electrolyte battery materials, (b) leaching the black mass with a hydrophobic deep eutectic solvent to extract critical metals, including lithium, cobalt, nickel and manganese, and generate a pregnant hydrophobic deep eutectic solvent, and (c) recovering the critical metals from the pregnant hydrophobic deep eutectic solvent.

In at least some of the many possible embodiments of the method, the leaching includes heating the black mass in the hydrophobic deep eutectic solvent to a temperature of between about 70° C. and about 140° C. for a sufficient period of time to extract the critical metals from the black mass.

In at least some of the many possible embodiments of the method, the recovering includes treating the pregnant hydrophobic deep eutectic solvent with a dilute oxalic acid or sodium oxalate solution to precipitate metal oxalates of cobalt, nickel and manganese. These metal oxalates may be recovered by filtering.

In at least some embodiments, the method further includes precipitating lithium salts from the pregnant hydrophobic deep eutectic solvent following the treatment with sodium carbonate solution or with ethanol, and vacuum evaporation at 70° C.

In at least some embodiments, the method further includes recovering the lithium salts that were previously precipitated by filtering.

In at least one embodiment, the recovering of the critical metals is by electrochemical deposition. In at least one embodiment, the recovering of the critical metals is by evaporation. In at least one embodiment, the recovery of the critical metals is by adsorption.

In some of the many possible embodiments, of the method, the method includes thermal treating the black mass prior to the leaching to produce a reduced black mass.

In the following description, there are shown and described several different embodiments of the new and improved hydrophobic deep eutectic solvent, the method of making that solvent and a method of recovering critical metals from lithium-ion batteries using that solvent. As it should be realized, the solvent and related methods are capable of other, different embodiments and their several details are capable of modification in various, obvious aspects all without departing from the solvent and methods as set forth and described in the following claims. Accordingly, the drawings and descriptions should be regarded as illustrative in nature and not as restrictive.

### BRIEF DESCRIPTION OF THE DRAWING FIGURES

The accompanying drawing FIGURE incorporated herein by reference and forming a part of the specification, illustrate several aspects of the solvent and methods and together with the description serve to explain certain principles thereof.

FIG. 1 is a schematic block diagram of the new and improved method of recovering critical metals for lithium-ion batteries.

Reference will now be made in detail to the presently preferred embodiments of the method for recovering critical metals for lithium-ion batteries using the new hydrophobic deep eutectic solvent.

### DETAILED DESCRIPTION

A new hydrophobic deep eutectic solvent includes a combination of two or more of the following: (a) a hydrophobic component, (b) an acidic component, and (c) a reducing agent. In one particularly useful embodiment, the solvent includes the hydrophobic component, the acidic component and the reducing agent. For further clarification, some compounds can play two roles at the same time. For example, in the case of binary DES between Menthol and ethylene glycol or glycerol, Menthol can act as both a hydrophobic and acidic component when mixed with ethylene glycol or glycerol. The lignin-derived hydrophobic deep eutectic solvents represent a new class of solvents that can selectively extract metals from the spent batteries. This new technology is circular, sustainable, and green and, therefore, can potentially replace the conventional hydrometallurgical process.

For the purposes of this document, the term “hydrophobic component” refers to compounds that are of intermediate and high molecular weight (i.e. a molecular weight greater than 180 Dalton) or are long chain hydrocarbons (i.e. hydrocarbons having a length of greater than six (6) carbon atoms with foreign atoms (O, N, P, S) or are cyclic hydrocarbons (i.e. hydrocarbons having a length of greater than five (5) carbon atoms with foreign atoms (O, N, P, S) that are either insoluble or sparingly soluble in water or if present in the solvent as a component, the solvent become insoluble in the water. Typically, the hydrophobic components are high molecular weight compounds having high melting (greater than 20° C.) and boiling points (greater than 160° C.) and are nonpolar in nature. In many applications, the hydrophobic component is lignin derived. This includes high molecular weight alkyl phenols, high molecular weight methoxy phenols, and high molecular weight ketones and alcohols with aliphatic and aromatic ring.

Lignin-derived hydrophobic components include, but are not necessarily limited to menthol, thymol, 2,2-dimethoxypropane (DMP), vanillin, 4-hydroxybenzyl alcohol, phenol and its derivatives, guaiacol, cresol, syringol, apocynin, and syringaldehyde. Other useful hydrophobic components include, but are not necessarily limited to, napthol and lidocaine.

The acidic component includes organic compounds that can donate a hydrogen bond (acts as a Lewis acid) to a hydrogen bond acceptor. It covers any compounds with one or more carboxylic acid functional groups as well as the compounds without carboxylic acid functional groups but acts as a Lewis acid in the DES system. Acidic components include, but are not necessarily limited to, acids including one or more carboxylic functional groups, decanoic acid, formic acid, citric acid, lactic acid, dodecanoic acid, succinic acid, ascorbic acid, malic acid, oxalic acid, malonic acid, adipic acid, benzoic acid and mixtures thereof.

Reducing agents useful in the solvent include, those that are solid or liquid at room temperature and capable of reducing metal ions during leaching by providing electrons. Such reducing agents include, but are nor necessarily limited to aliphatic and aromatic alcohols with one or more than one-OH functional group, amides, and amino acids. Such reducing agents include, but are not limited to ethylene glycol, glycerol, ascorbic acid, malic acid, glucose, urea, thiourea, acetimide, benzamide, glycine, alanine, sorbitol and mixtures thereof.

Various combinations of these components (i.e., Thymol/glycerol, DMP/glycerol, Decanoic acid/glycerol, Menthol/decanoic acid/ethylene glycol, thymol/decanoic acid/ethylene glycol, etc.) at different ratios (i.e., 1:1, 1:2, 1:1:1, 1:1:2, 1:2:1, 1:2:2, 1:1:1:1, 1:2:2:1, 1:1:2:2 etc.) are used to prepare the new solvents. More than one (a) hydrophobic component, (b) acidic component, and/or (c) reducing agent may be used in the hydrophobic deep eutectic solvent. Thus, various combinations of these components (i.e., Thymol/glycerol, DMP/glycerol, Decanoic acid/glycerol, Menthol/decanoic acid/ethylene glycol, thymol/decanoic acid/ethylene glycol, etc.) at different ratios (i.e., 1:1, 1:2, 1:1:1, 1:1:2, 1:2:1, 1:2:2, 1:1:1:1, 1:2:2:1, 1:1:2:2 etc.) are used to prepare the new DESs.

The method of making the hydrophobic deep eutectic solvents includes steps of: (a) mixing at least two of a hydrophobic component, an acidic component and a reducing agent together in a vessel to create a mixture, (b) heating the mixture to a temperature of about 80° C. for about two hours and (c) stirring the mixture continuously during heating to obtain the transparent hydrophobic deep eutectic solvent.

Tables I and II below include some examples of the new deep eutectic solvents useful for the recovery of critical metals such as lithium, cobalt, nickel, and manganese from spent, end-of-life lithium-ion batteries.

TABLE I
Any combination (binary, ternary, or quaternary) of these
compounds can be mixed to prepare deep eutectic solvents.
DES

| Hydrogen Bond | | |
|---|---|---|
| Acceptors (HBA) | Hydrogen Bond | |
| (Hydrophobic | Donors (HBD) | HBA/HBD |
| component) | (Acidic component) | (Reducing agent) |
| Menthol | Decanoic acid | Ethylene glycol (EG) |
| | Decanoic acid | Thymol |
| | Decanoic acid | DMP |
| | Thymol | Ethylene glycol (EG) |
| | Succinic acid | Ethylene glycol (EG) |
| | Formic acid | Ethylene glycol (EG) |
| Thymol | Decanoic acid | Ethylene glycol (EG) |
| | Decanoic acid | DMP |
| | Formic acid | Ethylene glycol (EG) |
| | Ethylene glycol (EG) | DMP |
| | Succinic acid | DMP |

Note:
*HBA = hydrogen bond acceptors and HBD = hydrogen bond donor HBA/HBD

TABLE II
Any combination of the components (as a binary,
ternary, or quaternary mixture) mentioned in the
table can be used to prepare deep eutectic solvents.
DES

| Hydrogen Bond | | |
|---|---|---|
| Acceptors (HBA) | Hydrogen Bond | |
| (Hydrophobic | Donors (HBD) | HBA/HBD |
| component) | (Acidic component) | (Reducing agent) |
| Menthol | Decanoic acid | Formic acid |
| | Decanoic acid | Lactic acid (LA) |
| | Decanoic acid | Citric acid |
| | Formic acid | Thymol |
| | Formic acid | DMP |
| | Formic acid | Lactic acid (LA) |
| | Citric acid | Ethylene glycol (EG) |
| | Citric acid | Thymol |
| | Citric acid | DMP |
| | Citric acid | Lactic acid (LA) |
| | Lactic acid | Ethylene glycol |
| | Butyric acid | Glycerol |
| | Valeric acid | Glycerol |
| | Decanoic acid | Glycerol |
| | Thymol | Glycerol |
| Thymol | Decanoic acid | Formic acid |
| | Decanoic acid | Lactic acid (LA) |
| | Decanoic acid | Citric acid |
| | Formic acid | |
| | Formic acid | DMP |
| | Formic acid | Lactic acid (LA) |
| | Citric acid | Ethylene glycol (EG) |
| | Citric acid | Thymol |
| | Citric acid | DMP |
| | Citric acid | Lactic acid (LA) |
| | Decanoic acid | Formic acid |
| | Butyric acid | Glycerol |
| | Valeric acid | Glycerol |
| | Decanoic acid | Glycerol |

The method of recovering critical metals from lithium-ion batteries, may be generally described as including the steps of: (a) shredding the lithium-ion batteries to separate metal container and shell components from a black mass including graphite, copper, cathode, anode and electrolyte battery materials, (b) leaching the black mass with a hydrophobic deep eutectic solvent to extract critical metals, including lithium, cobalt, nickel and manganese, and generate a pregnant hydrophobic deep eutectic solvent, and (c) recovering the critical metals from the pregnant hydrophobic deep eutectic solvent.

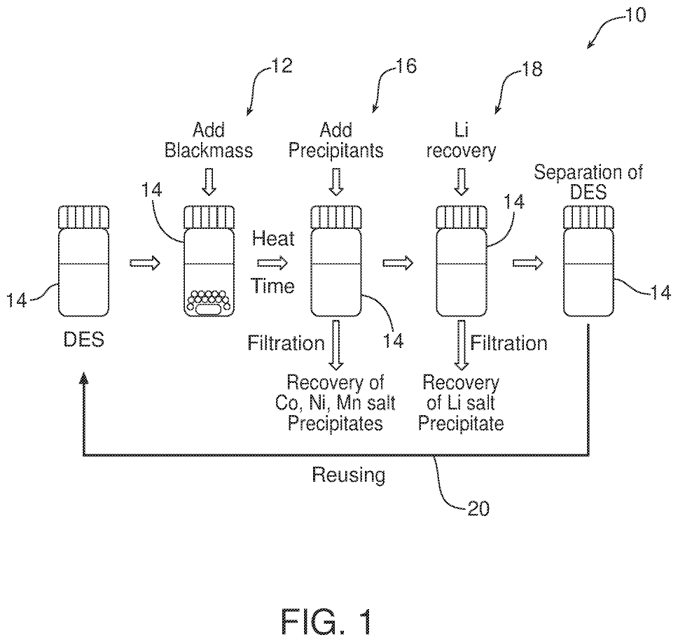

As shown in FIG. 1, the method 10 includes the step 12 of adding the black mass to a reaction vessel 14 and leaching by heating the black mass in the deep eutectic solvent to a temperature of between about 70° C. and about 140° C. for a sufficient period of time (for example, between 2-16 hours) to extract the critical metals from the black mass and generate a pregnant hydrophobic deep eutectic solvent. In some embodiments, the weight ratio of black mass to deep eutectic solvent is between about 1:30 and about 1:5. The pregnant hydrophobic deep eutectic solvent is then cooled down to room temperature. Any unreacted solid within the pregnant hydrophobic deep eutectic solvent is then separated from the leachate through centrifugation.

The recovering of the critical metals then includes the step 16 of adding a precipitant, such as dilute oxalic acid or sodium oxalate solution, to precipitate metal oxalates of cobalt, nickel and manganese. These precipitates may be recovered by filtering and drying in a manner known in the art to obtain a dry metal oxalate precipitate that may be subjected to further downstream processing for the recovery of the metals or other purposes.

Next, recovering the critical metals includes the step 18 of precipitating lithium salts from the pregnant hydrophobic deep eutectic solvent. In one possible embodiment, this is done by adding either a dilute sodium carbonate solution or ethanol with vacuum evaporation at 70° C. to obtain the precipitate of lithium salts. The lithium salt precipitate may be filtered and dried in a manner known in the art for subsequent processing or metal recovery. The resulting deep eutectic solvent is then recycled/reused (step 20).

In other embodiments of the method, the recovering of the critical metals is performed by other methods known in the art including, for example, by electrochemical deposition, by evaporation or by adsorption.

The black mass can either be directly added to the deep eutectic solvent for metal extraction as described above and shown in FIG. 1 or the black mass may first be subjected to thermal treatment to produce a reduced black mass before metal extraction. Such a thermal treatment in the presence of a reducing agent is known in the art and described in, for example, WO 2022/173705.

Tuning the properties of hydrophobic deep eutectic solvent will allow selective extraction of individual metal species from that solution. For example, formic acid-based hDES have shown selective leaching of lithium metals over the other critical metals from standard cathode materials and blackmass. Similarly, other components (hydrophobic, acidic, and reducing), their composition, and leaching conditions were varied to tune the viscosity, acidity, and selectivity of the hDESs.

This document may be said to relate to the following items.

1. A hydrophobic deep eutectic solvent, comprising: (a) a combination of a hydrophobic component and an acidic component, (b) the hydrophobic component and a reducing agent, (c) the acidic component and the reducing agent or (d) the hydrophobic component, the acidic component and the reducing agent.

2. The hydrophobic deep eutectic solvent of item 1, wherein the hydrophobic component is selected from a group consisting of a derivative of lignin, menthol, thymol, 2,2-dimethoxypropane (DMP), napthol, lidocaine, vanillin, 4-hydroxybenzyl alcohol, phenol, a derivative of phenol, guaiacol, cresol, syringol, apocynin, syringaldehyde and mixtures thereof.

3. The hydrophobic deep eutectic solvent of item 2, wherein the acidic component is selected from a group either acting as hydrogen bond donor or consisting of an acid including one or more carboxylic functional groups, decanoic acid, formic acid, citric acid, lactic acid, dodecanoic acid, succinic acid, ascorbic acid, malic acid, oxalic acid, malonic acid, adipic acid, benzoic acid and mixtures thereof.

4. The hydrophobic deep eutectic solvent of item 3, wherein the reducing agent is selected from a group consisting of ethylene glycol, diethylene glycol, glycerol, ascorbic acid, malic acid, glucose, urea, thiourea, acetimide, benzamide, glycine, alanine, sorbitol and mixtures thereof.

5. The hydrophobic deep eutectic solvent of item 1, wherein the acidic component is selected from a group consisting of decanoic acid, formic acid, citric acid, lactic acid, dodecanoic acid, succinic acid, ascorbic acid, malic acid, oxalic acid, malonic acid, adipic acid, benzoic acid and mixtures thereof.

6. The hydrophobic deep eutectic solvent of item 5, wherein the reducing agent is selected from a group consisting of ethylene glycol, diethylene glycol, glycerol, ascorbic acid, malic acid, glucose, urea, thiourea, acetimide, benzamide, glycine, alanine, sorbitol and mixtures thereof.

7. The hydrophobic deep eutectic solvent of item 1, wherein the reducing agent is selected from a group consisting of ethylene glycol, diethylene glycol, glycerol, ascorbic acid, malic acid, glucose, urea, thiourea, acetimide, benzamide, glycine, alanine, sorbitol and mixtures thereof.

8. The hydrophobic deep eutectic solvent of item 7, wherein the hydrophobic component is selected from a group consisting of a derivative of lignin, menthol, thymol, 2,2-dimethoxypropane (DMP), napthol, lidocaine, vanillin, 4-hydroxybenzyl alcohol, phenol, a derivative of phenol, guaiacol, cresol, syringol, apocynin, syringaldehyde and mixtures thereof.

9. A method of making a hydrophobic deep eutectic solvent, comprising:
mixing at least two of a hydrophobic component, an acidic component and a reducing agent together in a vessel to create a mixture;
heating the mixture to a temperature of at least 80° C.; and
stirring the mixture during heating.

10. A method of recovering critical metals from lithium-ion batteries, comprising:
shredding the lithium-ion batteries to separate metal container and shell components from a black mass including graphite, copper, cathode, anode and electrolyte battery materials;
leaching the black mass with a hydrophobic deep eutectic solvent to extract critical metals, including lithium, cobalt, nickel and manganese, and generate a pregnant hydrophobic deep eutectic solvent; and
recovering the critical metals from the pregnant hydrophobic deep eutectic solvent.

11. The method of item 10, wherein the leaching includes heating the black mass in the hydrophobic deep eutectic solvent to a temperature of between about 70° C. and about 140° C. for a sufficient period of time to extract the critical metals from the black mass.

12. The method of item 11, wherein the recovering includes treating the pregnant hydrophobic deep eutectic solvent with a dilute oxalic acid or sodium oxalate solution to precipitate metal oxalates of cobalt, nickel and manganese.

13. The method of item 12, further including precipitating lithium salts from the pregnant hydrophobic deep eutectic solvent following the treating either with the sodium carbonate solution or with ethanol and vacuum evaporation at 70° C.

14. The method of item 13, including recovering the lithium salts that were previously precipitated by filtering.

15. The method of item 10, wherein the recovering of the critical metals is by electrochemical deposition.

16. The method of item 10, wherein the recovering of the critical metals is by evaporation.

17. The method of item 10, wherein the recovery of the critical metals is by adsorption.

18. The method of item 10, further including thermal treating the black mass prior to the leaching.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a reducing agent”, as used herein, may also refer to, and encompass, a plurality of reducing agents.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified. Terms of approximation, such as the terms about, substantially, approximately, etc., as used herein, refers to ±10% of the stated numerical value.

Although the hydrophobic deep eutectic solvents and related methods of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A hydrophobic deep eutectic solvent, comprising: (a) a combination of a hydrophobic component and an acidic component, (b) the hydrophobic component and a reducing agent, (c) the acidic component and the reducing agent or (d) the hydrophobic component, the acidic component and the reducing agent.

2. The hydrophobic deep eutectic solvent of claim 1, wherein the hydrophobic component is selected from a group consisting of a derivative of lignin, menthol, thymol, 2,2-dimethoxypropane (DMP), napthol, lidocaine, vanillin, 4-hydroxybenzyl alcohol, phenol, a derivative of phenol, guaiacol, cresol, syringol, apocynin, syringaldehyde and mixtures thereof.

3. The hydrophobic deep eutectic solvent of claim 2, wherein the acidic component is selected from a group either acting as hydrogen bond donor or consisting of an acid including one or more carboxylic functional groups, decanoic acid, formic acid, citric acid, lactic acid, dodecanoic acid, succinic acid, ascorbic acid, malic acid, oxalic acid, malonic acid, adipic acid, benzoic acid and mixtures thereof.

4. The hydrophobic deep eutectic solvent of claim 3, wherein the reducing agent is selected from a group consisting of ethylene glycol, diethylene glycol, glycerol, ascorbic acid, malic acid, glucose, urea, thiourea, acetimide, benzamide, glycine, alanine, sorbitol and mixtures thereof.

5. The hydrophobic deep eutectic solvent of claim 1, wherein the acidic component is selected from a group consisting of decanoic acid, formic acid, citric acid, lactic acid, dodecanoic acid, succinic acid, ascorbic acid, malic acid, oxalic acid, malonic acid, adipic acid, benzoic acid and mixtures thereof.

6. The hydrophobic deep eutectic solvent of claim 5, wherein the reducing agent is selected from a group consisting of ethylene glycol, diethylene glycol, glycerol, ascorbic acid, malic acid, glucose, urea, thiourea, acetimide, benzamide, glycine, alanine, sorbitol and mixtures thereof.

7. The hydrophobic deep eutectic solvent of claim 1, wherein the reducing agent is selected from a group consisting of ethylene glycol, diethylene glycol, glycerol, ascorbic acid, malic acid, glucose, urea, thiourea, acetimide, benzamide, glycine, alanine, sorbitol and mixtures thereof.

8. The hydrophobic deep eutectic solvent of claim 7, wherein the hydrophobic component is selected from a group consisting of a derivative of lignin, menthol, thymol, 2,2-dimethoxypropane (DMP), napthol, lidocaine, vanillin, 4-hydroxybenzyl alcohol, phenol, a derivative of phenol, guaiacol, cresol, syringol, apocynin, syringaldehyde and mixtures thereof.

9. A method of making a hydrophobic deep eutectic solvent, comprising:
mixing at least two of a hydrophobic component, an acidic component and a reducing agent together in a vessel to create a mixture;
heating the mixture to a temperature of at least 80° C.; and
stirring the mixture during heating.

10. A method of recovering critical metals from lithium-ion batteries, comprising:
shredding the lithium-ion batteries to separate metal container and shell components from a black mass including graphite, copper, cathode, anode and electrolyte battery materials;
leaching the black mass with a hydrophobic deep eutectic solvent to extract critical metals, including lithium, cobalt, nickel and manganese, and generate a pregnant hydrophobic deep eutectic solvent; and
recovering the critical metals from the pregnant hydrophobic deep eutectic solvent.

11. The method of claim 10, wherein the leaching includes heating the black mass in the hydrophobic deep eutectic solvent to a temperature of between about 70° C. and about 140° C. for a sufficient period of time to extract the critical metals from the black mass.

12. The method of claim 11, wherein the recovering includes treating the pregnant hydrophobic deep eutectic solvent with a dilute oxalic acid solution or sodium oxalate solution to precipitate metal oxalates of cobalt, nickel and manganese.

13. The method of claim 12, further including precipitating lithium salts from the pregnant hydrophobic deep eutectic solvent following the treating either with the sodium carbonate solution or with ethanol and vacuum evaporation at 70° C.

14. The method of claim 13, including recovering the lithium salts that were previously precipitated by filtering.

15. The method of claim 10, wherein the recovering of the critical metals is by electrochemical deposition.

16. The method of claim 10, wherein the recovering of the critical metals is by evaporation.

17. The method of claim 10, wherein the recovery of the critical metals is by adsorption.

18. The method of claim 10, further including thermal treating the black mass prior to the leaching.
